(19) United States
(12) Patent Application Publication
(10) Pub. No.: US 2008/0229495 A1
(43) Pub. Date: Sep. 25, 2008

(54) MOTIVATIVE EXERCISE AND LIFTING AID DUAL DEVICE

(75) Inventor: Shigeo Takizawa, Fujisawa (JP)

Correspondence Address: Shigeo Takizawa, 24-5, Shounandai 4Chome, Fujisawa, 252-0804, JP

(73) Assignee: BIOPHILIA INSTITUTE INC., Fujisawa (JP)

(21) Appl. No.: 11/161,069

(22) Filed: Jul. 21, 2005

Related U.S. Application Data
(63) Continuation-in-part of application No. 10/311,917, filed on Mar. 4, 2003, now Pat. No. 6,978,497.

(51) Int. Cl. A61G 7/10

(52) U.S. Cl. 5/86.1

(57) ABSTRACT

To be possible to replace a grip (23) in the FIG. 11 by the effect of a dual grip end (111b) therefore usability of MOTIVATIVE EXERCISE AND LIFTING AID DUAL DEVICE to upraise and aforesaid wrist part (111) which attached onto the upper extremities exercise rope by attachment part (222) attached to the upper extremities exercise device to insert the disabled side wrist of motivative exercise person with the wrist inserting position (3) and with the wrist stationary part (444) which was movably attached to the wrist part (111).

The present invention is a Continuation-in-Part application of U.S. patent application Ser. No. 10/311,917, filed on Mar. 4, 2003, currently pending.

### FIELD OF THE INVENTION

This invention is for the care of gait difficulties who cannot leave a bed by themselves.

This invention enables to reduce the labor of the care person and to move the handicapped patients confidently for the care work to do indoor with such as steps or gaps.

This invention is to improve a transfer-move lifting aid to use smoothly and for a lifting aid with a tying a device for training of upper extremities which enables patients to rehabilitate at home by the motivative exercise for upper extremities easily and properly.

Furthermore, this invention is related to a shape-memory grip with universal lock to enable an upper extremities exercise by oneself when patients who have hemiplegia by a sequela of the brain blood device difficulty, the upper extremities training is necessary by whose left or right upper extremities are paralyzed and not to seize the grip of the upper extremities training device by oneself (included in the Motivative exercising person), as a parts of MOTIVATIVE EXERCISE AND LIFTING AID DUAL DEVICE.

### BACKGROUND OF THE INVENTION

Many kinds of lifting aids as a handicapped person's care devices have been provided in multiple needs such as bathing assistance.

The lifting aids are used as an assistant device to make handicapped persons sit up and move easily

However it is the most desirable that a care should effect handicapped people independent, but its realization has been difficult.

At the same time, lifts aids with wheels did not come into practical use in the situation where gaps and steps were obstacles. It is known popularly that lifting aids of ceiling tying type has been in wider use.

This inventor is applying the device for a motivative exercise of lower extremities.

The motivative exercise of lower extremities enables to prevent the contracture of equines position by the after effect of cerebrovascular disease.

And/or the motivative exercise is able to control the appearance of the spasticity by both using of the paralyzed part of the nervous system and the inhibition mechanism of controlling the mover and antagonist in order to the patients who became the condition of contracture of equines position.

It is also rational to think that the motivative exercise of upper extremities enables to control the appearance of the spasticity by both using of the paralyzed part of the nervous system and the inhibition mechanism of controlling the mover and antagonist in order to the patients who became the condition of contracture of equines position.

This invention is intended to offer the combination device of both a motivative exercise device of upper extremities and a lifting aid;

the motivative exercise device can be used for making the handicapped people be independent form care reliance and

the lifting aids can be used and handled easily in the situation where the thresholds and gaps are obstacles and to get over the obstacles without any difficulties.

This device is useful for both a care and an independence of handicapped people at home. And, the name of the combination device of both the lifting aids and upper extremities function training device is to be “motivative exercise and lifting aid dual device.”

A grip of the part for the upper extremities training device is well known. And it is consists of a rope and grips which are attachable in both ends of the rope.

Also, there is a belt-shaped band, with a clasp, to wear on the wrist at every time in use. It is known to put on the hand with the paralysis, and get fixed on to the grip as gloves This applicant have published a device to keep a wrist that consist of a sheet of cloth to process the circumference of a wrist, which is shaped roughly rectangular and made of flexible material, and two attachable parts, which are made of two piece of string, made of flexible materials and shaped semicircular, are attached on both sides of the cloth to process the circumference of a wrist.

In this applicant, the Motivative exercise is defined as the movement of a functional extremity leads the movement of the impaired extremity by the use of devices and the Takizawa method is formed in order to perform the rehabilitation and muscle power strengthening to rehabilitate and to strengthen the muscle power with the Motivative exercise predominantly.

Additionally, this applicant has reported the principle of the Takizawa method for rehabilitation and the Motivative exercise as follows:

The Development of Devices for the MOTIVATIVE Exercise of Impaired Extremities. Paper presented at: the CSUN Conference. Los Angeles. Mar. 22, 2000: Session 166; The Rehabilitation Trial to Reacquire Walking from Bedridden Patients at the Bedridden Elderly Hospital. Journal of the Japanese Clinical Orthopedic Association. Vol. 23. NO. 2 Jun. 1998: 186-191;

The Development of Devices for the Motivative Exercise of Impaired Extremities. The 4678 Journal of Kouseihukusi (Welfare). the 4833rd jiji press. May 17, 2000: 2-5.

In the above announcement, it is reported to enforce the upper extremities training using the upper extremities training device, for the patient's upper extremities in need of training due to paralysis.

In above announcement, the exercise devices with a part for the upper extremities training which consists of a rope with grips attachable in both ends and a towel or a contrived device to keep a wrist to fix to the grip are used with enabling to fix and keep patient's hand on the grip.

### DISCLOSURE OF THE INVENTION

The motivative exercise and lifting aid dual device is composed of leg poles (3a, 3b) which have casters (2), a hardware box (4), wheels (5), a guide (6) that attached to the hardware box, a hoisting part (7), a running-pulling arm (8), a hoisting driving part (9) that make the hoisting part go up and down and a hoisting controller (10) that controls the hoisting driving part.

A hoisting part (7) and a running-pulling arm component (8a) are installed in the guide (6) to control possible.

There is a case that the motivative exercise and lifting aid dual device has leg poles (3a, 3b) which has casters (2) with plates (1).

There is a case that the motivative exercise and lifting aid dual device have a member of the tying device for training of upper extremities (11) which is set up at the hardware box.

There is a case that the motivative exercise and lifting aid dual device have a member of the tying device for training of upper extremities (12) which is set up at the guide.

There is a case that the motivative exercise and lifting aid dual device have a tying device for training of upper extremities (14) which is assembled into said members of the tying device for training of upper extremities.

There is a case that the running-pulling arm (8) has a running-arm and-a pulling arm respectively.

There is a case that the running-pulling arm (8) has a hole (13) for the tying device for training of upper extremities.

There is a case that the motivative exercise and lifting aid dual device have a power-assist mechanism known in public in the wheel (5).

There is a case that the running-pulling arm (8) is removed when the tying device for training of upper extremities is set up.

In the case of using the device to keep a wrist that is a belt-shaped band, with a clasp, to wear on the wrist at every time, it is necessary to adjust it to each person to exercise motivative exercise (or person) or patient to rehabilitate (or patient) by the exercise manager (or manager).

In the case of using the exercise device, which enables to train the upper extremities by fixing and keeping patient's or person's hand on the grip with using the glove-like device to put on the hand with the paralysis, or the invented device to keep a wrist by this applicant has already presented to fix and keep patient's hand on the grip, the work of a manager is also required.

It is hard to use the training device for the upper extremities by hand with paralysis because a patient or a person who has the paralysis can't use the grip with the helping devices to keep by oneself.

Also in the invented device presented by this applicant, it needed the manager to keep a patient's and/or a person's affected hand fixed to the grip, and the device constricted patient's wrist too much.

This invention improves the necessity of keeping the expensive upper extremities training device in many and downsizes those to keep by using the invented shape-memory grips. And this invention has the purpose of reducing the labor of the manager to make patients rehabilitate or persons begin motivative exercise with whose affected hand not easy to hold a grip due to fixing the affected hand to the grip using a device to keep a wrist.

And, the purpose of this invention is to eliminate the necessity of installing the grip again after one person's or patient's exercise in order to keep the affected hand only by a device to keep a wrist, for another person and/or patient (or people) who can hold the grip. Also, the purpose of this invention is to eliminate the necessity of installing the belt-shaped band which has a clasp, to wear on the wrist at every time in use and to adjust to each people.

Another purpose of this invention is to reduce a labor in re-tying a grip and a rope through the rope in the hole of the grip, or to put over the glove-like device to on the hand with the paralysis to get fixed on to the grip.

And also it will improve the usage of a grip, which is a combined structure.

A manager must wind the device to keep a wrist, which is published by the applicant to the wrist of people when people exercise their upper extremities.

And then it is necessary for the manager to make one of two attachments path through the other one in order to install at the junction of the rope, therefore people cannot use the device alone.

There are other purposes to improve the above disablement and to stop the excessive tightening of a wrist.

### BRIEF DESCRIPTION OF THE DRAWINGS

FIG. 1 is a perspective view that shows a motivative exercise and lifting aid dual device as a whole.

FIG. 2 is an elevation view of the same embodiment.

FIG. 3 is the side view elevation view of the same embodiment.

FIG. 4 is a bottom plan view of the same embodiment.

FIG. 5 is an expanded sectional view of A-A′ of the same embodiment.

FIG. 6 is a perspective view of a lifting aid in use of the same embodiment.

FIG. 7 is a perspective view of a tying device for training of upper extremities in use of the same embodiment.

FIG. 8 is a side-view, which shows a main section of the second embodiment of this invention.

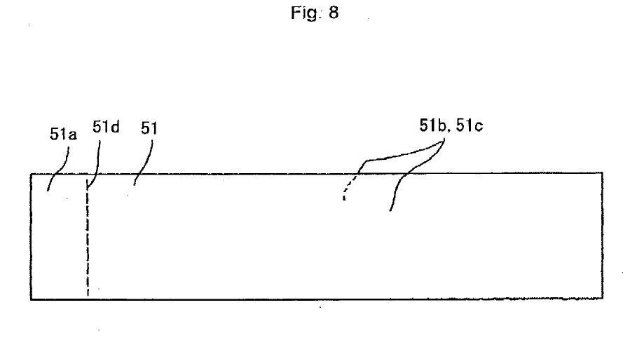

FIG. 9 is the plain view of the second embodiment of this invention.

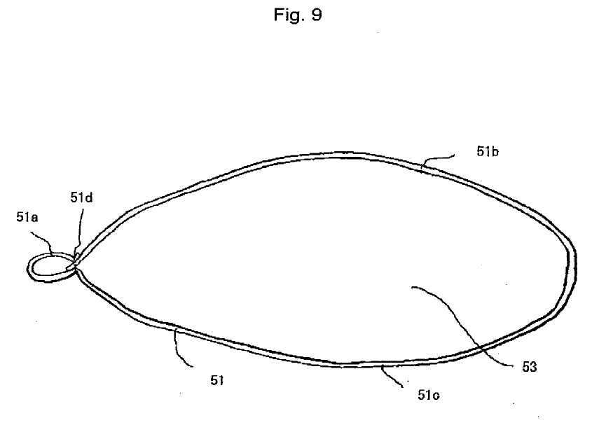

FIG. 10 is a reference figure, which shows a main section of the second embodiment of this invention.

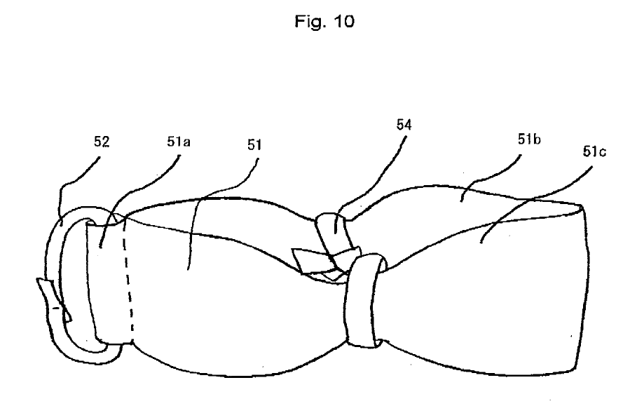

FIG. 11 is a reference view, which shows using situation of this invention.

FIG. 12 is a reference view which shows using situation of this invention.

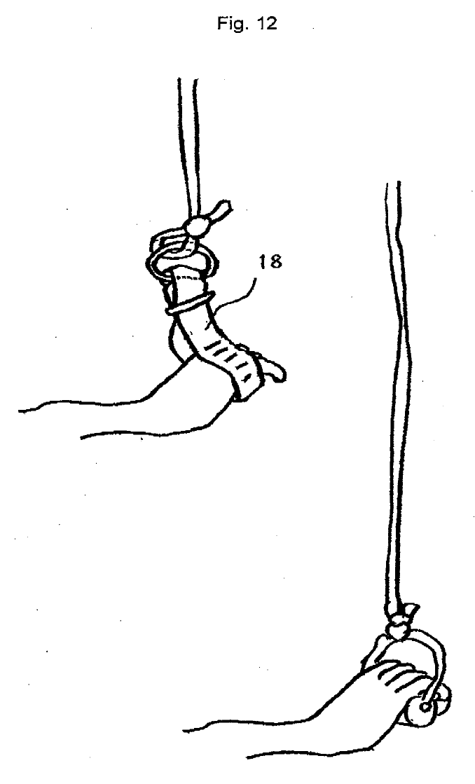

FIG. 13 is a reference drawing, which shows a main section of the third embodiment of this invention.

FIG. 14 is a plain view of the forth embodiment of this invention.

FIG. 15 is a side-view of the forth embodiment of this invention.

FIG. 16 is a reference view, which shows using situation of the forth embodiment.

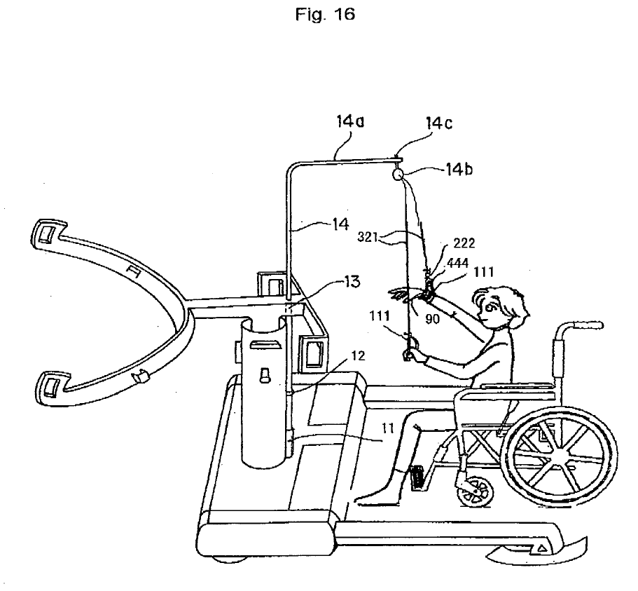

### DETAILED DESCRIPTION OF THE PREFERRED EMBODIMENT

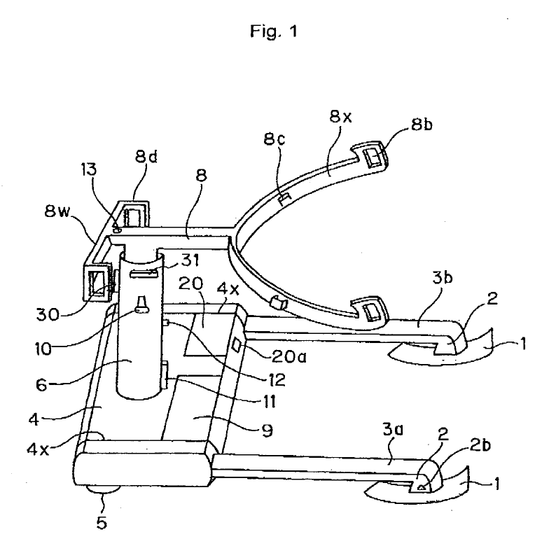

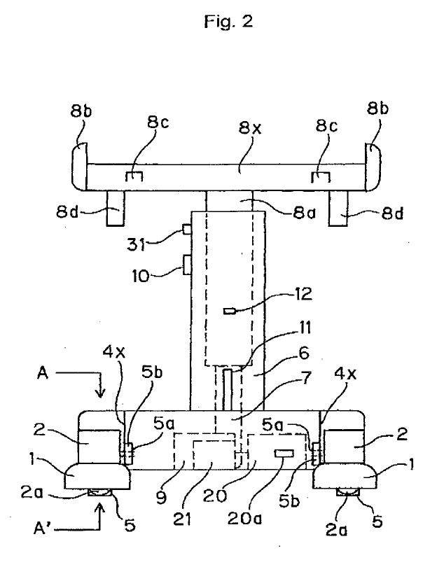

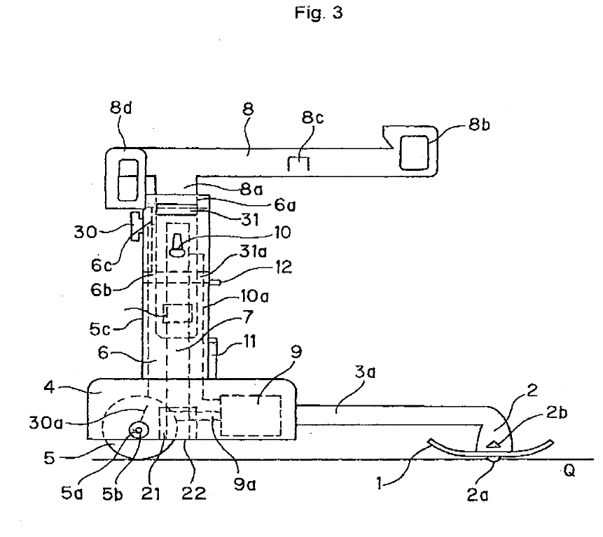

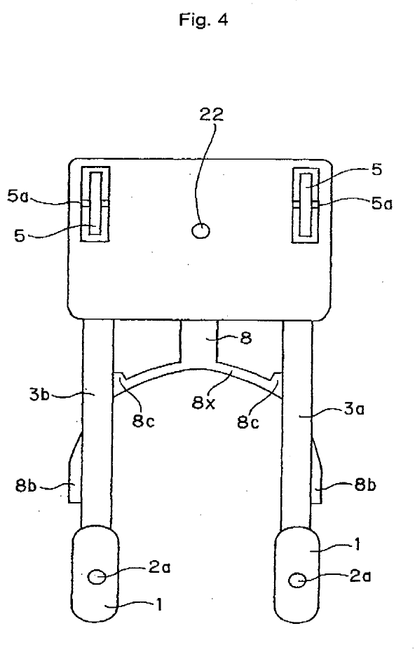

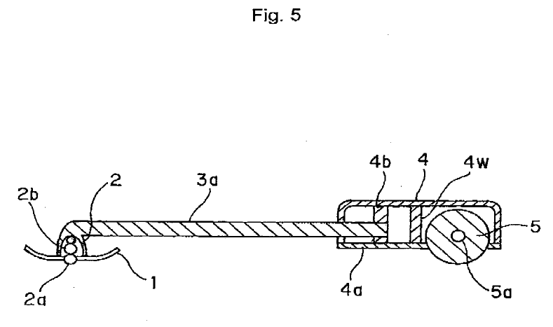

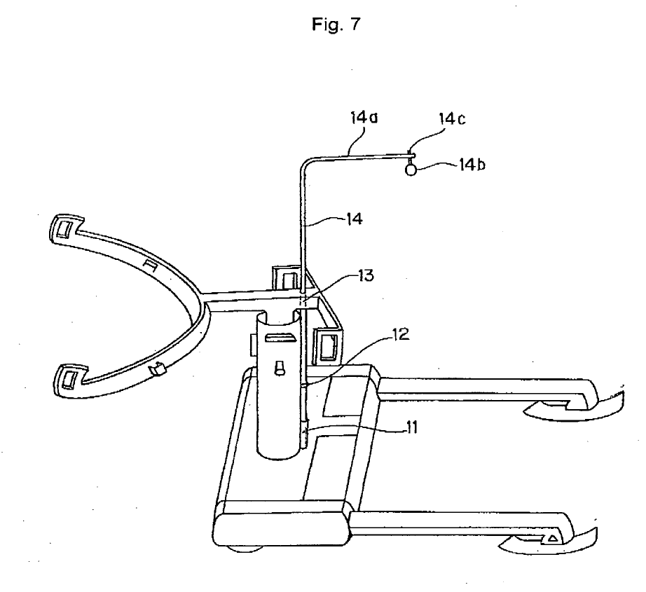

Then the inventor describes the embodiment in accordance with FIGS. 1 to 7.

A motivative exercise and lifting aid dual device has enough height to raise a person who can't sit up from the bed by oneself and it has stable length for the upper extremities training.

For an example in this embodiment, the height from a surface to move (Q) to the running-pulling arm (8) of the motivative exercise and lifting aid dual device is 80 cm, the entire length of the device is 90 cm and the width of the device is 60 cm.

The height of the tying device for training of upper extremities is 180 cm in use.

It is sufficient for those who have difficulty in sitting up by themselves that the device has enough height to raise them up on the bed and has a stable length for the upper extremities training to practice.

A motivative exercise and lifting aid dual device has leg poles (3a, 3b) which have casters (2) with plates (1) in order to get over the obstacles such as thresholds and gaps for moving at surfaces to move.

Even casters of JP 2979170 can substitute casters (2) with plates (1).

A caster (2) is composed of a wheel (2a) that is a ball and a brake of operating a plate (1) by hand in this embodiment.

The degree of the free movement of this invention is relatively high by shaping plate (1) to rise in the front and at the back in the same time.

Stability of this invention is secured by pulling up a wheel (2a) upward by the caster control device (2b) when the upper extremities' training is in practice.

Leg poles (3a, 3b) is composed by a pair of the corner shaped aluminum pipe and covered with the material which has a fixed elasticity such as urethane form and/or rubber in order to have waterproof and to secure safety.

Leg poles (3a, 3b) go through holes (It isn't illustrated) that set up in the front wall on the side of the hardware box (4) and are inserted into the inside of the hardware box (4), A hardware box (4) is made of the plastic.

Lines (4x) of the hardware box (4) are made lines at assemble members (4b) and the bearing housings which are composed between the hardware box (4) and the base (4a). The bearing housings are assembled of the axle (5a) for the wheel (5) and have the waterproof function.

In other words, the hardware box (4) is divided into three rooms in the position of two lines (4x).

Leg poles (3a, 3b) are fixed by assemble members (4b) that are assembled between the upper part of a hardware box (4) and a hardware base (4a) inside of the hardware box (4) in the stability.

A hardware base (4a) is made of a plastic.

The hardware box (4) is a united structure without the hardware base (4a).

Though it isn't illustrated in this embodiment, the hardware box (4) and the hardware base (4a) are attached with screws and given waterproof processing with gland packing. Assemble members (4b) are assembled between the hardware box (4) and the hardware base (4a) to ensure the safety of the leg poles (3a, 3b).

An assemble member (4b) is glued to the hardware box (4) and the hardware base (4a).

The assemble members (4b) are used in order to secure the leg poles (3a, 3b) that go through the perforated hole on the front side of the hardware box (4), in the stability in this embodiment.

The leg poles can be integrated with the hardware box (4) and the hardware base (4a) and/or means for assembling the leg poles such as welding and screw clamp are available in order that the leg poles (3a, 3b) are assembled in the stability.

Though it isn't illustrated, wheels (5) and axles (5a) are composed in the inside of a hardware box (4) on the place between the sidewall of the hardware box (4) and the position of the make-up line (4x).

A waterproofing wall (4w) is assembled between inside of the sidewall of the hardware box (4) and an inner wall shown with the make-up line (4x).

The inner wall shown with the make-up line (4x) and the waterproofing wall (4w) are provided to waterproof the driving part (9) and the energy supply device (20).

These are not required when each the driving part (9) and the energy supply device (20) itself are waterproofed.

Bearing housings of the axle (5a) for the wheel (5) can be assembled separately in the former case.

A brake (5b) is assembled on the axle (5a) through the inner wall shown with the make-up line (4x).

Though a drum brake is being used for the brake (5b) in this embodiment, any kind of brake can be used.

When a brake switch (30) is pushed, the brake (5b) works through the cable (30a) and stops the movement of the motivative exercise and lifting aid dual device.

When the brake switch (30) is pushed, the brake device brakes.

Though it isn't illustrated, the brake switch (30) has a lock system that enables to keep the braked condition after pushing the switch.

The brake switch (30) has to be pushed again to release the brake.

The brake has to be locked in the use of the motivative exercise and lifting aid dual device for the upper extremities exercise.

The brake can also be locked in conjunction with the caster (2) due to operating the caster control device (2b).

A driving part (9) which drives a running-pulling arm (8), an energy supply (20), a power transmission (21) which transmits the power from the driving part (9) to the hoisting part (7) and a hoisting part securement (22) that enables to turn the hoisting part (7) freely, are composed on the hardware base (4b).

A driving part (9) is a motor in this embodiment.

An energy supply (20) is a storage battery.

A terminal (20a) is assembled on the front surface of the hardware box (4).

A terminal (20a) supplies electric power to the energy supply (20) which is a storage battery. The rotation of a shaft (9a) by the rotation of the driving part (9) is transmitted to the hoisting part (7) by the gear rotation of the power transmission (21) with a gear.

The hoisting part (7) is assembled where a hoisting part securement (22) and rotates.

The hoisting part (7) is the screw mechanism that a screw was framed.

A running-pulling arm component (8a) which is related apparatus of the running-pulling arm (8) for hoisting is hollow and assembles a hoisting part (7).

The running-pulling arm component (8a) and the hoisting part (7) that a screw is framed are assembled to the running-pulling arm component (8a) with the nut mechanism (87) that is fixed to the running-pulling arm component (8a) with rotation freely.

A running-pulling arm (8) moves up and down based on the rotation of the hoisting part (7) as a nut moves by the rotation of the screw.

The hoisting controller (10) is assembled in the guide (6) and is connected to the driving part (9) with the hoisting controller transmission line (10a).

A motor of the driving part (9) rotates as the running-pulling arm (8) will rise when care person pulls the hoisting controller (10) toward to the care people in other words on the side of a running-arm (8w) of the running-pulling arm (8) on the FIG. 1 in this embodiment.

When the hoisting controller (10) is pushed on the opposite direction, the running-pulling arm (8) descends.

The direction of the rotation of the motor is set up with the installation of a screw cutting. A clutch mechanism can be assembled in the power transmission (21) that is a gear mechanism.

In the former case, it is good that such as a rotary switch substitute for the hoisting controller (10) and control the clutch mechanism.

The guide (6) is composed of an integrated combination of the hardware box (4).

And then a stable device (6a) is assembled at the upper part of the guide (6) and a stable device (6b) is assembled at the inside of the guide (6).

Because the guide (6) is composed of an integrated combination of the hardware box (4) and the stable device (6a) and the stable device (6b) are assembled, the hoisting part (7) and a running-pulling arm component (8a) to move the running-pulling arm (8) up and down can be secured in the stability

When the running-pulling arm component (8a) has moved to the highest position, the bottom part of the running-pulling arm component (8a) will not overstep the stable device (6b).

The running-pulling arm component (8a) is always secured by the stable device (6a) and the stable device (6b). Therefore, an up-down movement is done in the range of 15 cm.

A stable device control mechanism (31) is assembled at the top of the hoisting part (7)

The stable device control mechanism (31) is a brake switch, which applies a brake when it is pushed.

The stable device control mechanism (31) controls the stable device (6a) and the stable device (6b) that are breaks which have smooth surface not to obstruct the rotation and/or the up-down movement of the running-pulling arm component (8a),

The stable device (6a) and the stable device (6b) are stable devices for the running-pulling arm component (8a) in the case that they are not used as a break.

And then, the stable device (6a) and the stable device (6b) will not obstruct the rotation of the running-pulling arm (8) in times of lifting a handicapped person for transference and/or preparing to use.

Synthetic rubbers are used for the surface of the stable device (6a) and the stable device (6b) in the embodiment.

A brake works by the indication of the stable device control mechanism (31) in times to transfer a handicapped person.

An indication of the stable device control mechanism (31) is transmitted by a control transmission cable (6c).

The control transmission cable (6c) is a brake cable.

The stable device (6a) and the stable device (6b) put a drum break to use for the running-pulling arm component (8).

The stable device control mechanism (31) has a lock mechanism, though it is not illustrated.

When the brake brakes by pushing it then the brake stays to be on.

You need to push once again in order to release the break.

When you transfer a handicapped person, it is used with the brake locks on.

A running-pulling arm (8) is composed of a running-pulling arm component (8a), a running arm (8w), and a pulling arm (8x).

A nut mechanism (87) is fixed to the running-pulling arm component (8a).

By the effect of the nut mechanism (87), the running-pulling arm (8) moves up and down by the rotation of the screw of the hoisting part (7).

Running-grips (8d) and a hole (13) for the tying device for training of upper extremities are assembled in the running-arm (8w).

Keeping bosses (8c) and keeping grips (8b) for a boatswain's chair (40) is assembled on a pulling arm (8x).

The running-pulling arm (8) is made unified by aluminums, and it can hoist an object weigh up to 200 kilograms.

The running-pulling arm (8) contains enough strength to use as a lifting device for the motivative exercise and lifting aid dual device.

Though the running-pulling arm (8) is an aluminum casting in the embodiment, if it has enough strength for the use as a lifting aid, it is also good such as a plastic casting.

Also, it is made unified as the running-pulling arm, but it may be constructed separately as a running arm and a-pulling arm.

Running-grips (8d) are assembled to be convenient for the use of the care person. A form can be taken in other forms. For example, it may take a form like a car handle.

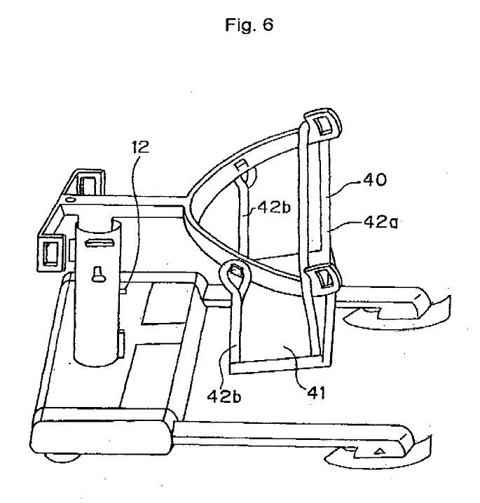

A boatswain's chair (40) is set on the two keeping bosses (8c) and keeping grips (8b) that are set on a pulling arm (8x) as shown in FIG. 6.

A boatswain's chair (40) is consisted of a seating part (41) which is made of wood and bell ropes (42a, 42b) which are made of strengthening nylon.

The bell ropes (42a, 42b) in FIG. 6 can bear to the load of 100 kilograms.

It can be changed by the user's weight.

The bell rope (42a) is annular but it also enables to be in an independent cord as the bell rope (42b).

The bell rope (42) and the bell rope (42a) are used adjusting length by a user's height.

It is good that the seat part (41) could have a component to install to the member of the tying device for training of upper extremities (12) in order to enhance stability.

The running-pulling arm (8) is set not to overstep the stable device (6b) that is set on the guide (6) in the embodiment, but it can overstep the stable device (6b) if the stable device (6a, 6b) are enable to liberate greatly,

Therefore, the running-pulling arm (8) is removable.

Also, if the hoisting part (7) is shaped as a pipe—and a hollow form, the running-pulling arm (8) can be removed and then the tying device for training of upper extremities (14) enable to insert inside and to use.

A tying device for training of upper extremities (14) is a pipe which measures about 165 cm and is bent at the top in the abbreviation of 90 degrees angle.

In the embodiment, an erector pipe manufactured by Yazaki-Kakou is being used.

The bent and processed part is abbreviation of 40 cm. And though it isn't illustrated, a hole was assembled in order to insert a screw (14b) that has a ring part and the screw (14b) is fixed by the nut (14c) at the top part.

When it is actually used, a pulley that is composed of a part for the upper extremities training device is set on the ring part

In the embodiment, the tying device for training of upper extremities (14) stands from the hardware box (4).

The tying device (14) goes through a member of the tying device for training of upper extremities (11) which is glued and fixed to the guide (6), a member of the tying device for training of upper extremities installation device (12) which is glued and fixed to the guide (6) and a hole for the tying device for training of upper extremities (13) respectively for training of upper extremities.

Heretofore, the inventor have explained the embodiment of this invention in detail, however it isn't limited to the embodiment, it is possible to make various changes from the embodiment within the confine of the claims of this invention.

The change example of this invention is illustrated in the following.

(1) Although a guide that goes up and down is set at a hardware box that is a machine storage part, the guide also can be assembled into the bottom of the hardware box as a base, too.

It also is possible to not set a guide which goes up and down.

It also can be changed according to the movement structure of up and down going of the hoisting part.

For example, a winch could be used to control the up and down movement of the hoisting part by hand.

In such case, a manual handle can take place to the hoisting controller that controls the hoisting driving part.

(2) The arrangement of the wheels and its quantity can be changed appropriately.

Though, it is preferred to assemble the wheels in every direction of the bottom in order to use as a transfer-move lift or for the upper extremities training of the motivative exercise and lifting aid dual device.

(3) The boatswain's chair can be set on a pulling arm.

Two keeping bosses and two keeping grips were arranged on the pulling arm but arrangement and quantity could be changed appropriately.

Also, the seat is made of wood, but the unity formed material with enough strength like plastic could also can be used.

Convenience levels rise more if it is constructed in the form of the toilet seat.

(4) A pipe bent in the abbreviation ninety degrees is used for the tying device for training of upper extremities (14).

It is possible to use such as a stainless steel pipe instead of the ready-made pipe in the embodiment.

It is also good even if not to be a round-shaped pipe.

In other word, if a material can support the pulling movement of up to 60 kilograms, any material can be used.

The second embodiment is explained in accordance with the code of the figure.

A wrist part (51) is a part to process the circumference of a wrist (90) and an approximate rectangle, which consists of the supple quality of the material.

The wrist part consists of an adherence part (51a) and both sides' parts (51b, 51c) and an attachment (52).

In this embodiment, the wrist part (51) is about 20 cm length, about 5 cm width, and about 3 mm thick.

A wrist part (51) consists of cloth, which is a towel, and both ends are sutured.

An adherence part (51a) is a structure, which enables attachment (52) to attach by suturing the both ends in the position of welting (51d).

The attachment (52) is an attachable division to a training rope (321) for upper extremities. A dual device (18) of a grip and a sling consists of a wrist part (51), an attachment (52) and a wrist stop (54).

In this embodiment, fabric string with about 5 mm width and about 12 cm length is used for the attachment (52), with both ends sewed on together.

Therefore the adherence part (51a) is formed as a slotted hole, which enables attachment (52) to pass through.

Both sides' parts (51b, 51c) are the sign for the explanation of the wrist part (51) which has both ends sutured.

A position to insert a wrist (53) is a position to insert a wrist (90) where people's wrist is set through and the wrist part (51) consists it.

A wrist stop (54) consists of optional material, and in this embodiment, stretchable nylon cloth about 15 cm such as women's socks is used. It is attached movable on both sides' parts (51b, 51c) of the wrist part (51) in the 8 knot.

This embodiment consists of the above composition.

In the utilization, insert the affected side wrist of people through at a wrist inserting position (53), which is constructed of the wrist part (51) that is attached onto a rope to exercise upper extremities (321).

And the rope to exercise upper extremities (321) is attached to a device of the upper extremities exercise.

Afterward, the wrist stop (54) is pulled down and the wrist of people is kept enabling to the motivative exercise and rehabilitation.

The exercises of the upper extremities are done after that.

The towel cloth is used for a part to process the circumference of a wrist in this embodiment, but any kind of materials can be used such as the leather or plastic, if it is the material that does not injure the wrist of people in the exercise of the upper extremities. The fabric strap of about 5 mm thick is used in the attachment, but if the part to process the circumference of a wrist is secured to a rope of exercises for the upper extremities, and does not get released during the exercises, materials such as stainless or iron ring, firmly tied vinyl strap, can be used.

Also in this embodiment, adherence part (51a) is used as setting a rope through it, but it is good if it can be attached in some way as sewing onto the part to process the circumference of a wrist.

By using a device to keep a wrist instead of a grip, when using the device to keep a wrist without a grip by an affected hand, it may be firmly fixed to the rope for the upper extremities exercise.

It will be easier to use by using shape-memory materials in that case.

A wrist stop, which consists of a nylon fabric about 15 cm with both ends, tied attached to the part to process the circumference of a wrist.

But the wrist stop is a part to keep the wrists to enable exercises of the upper extremities, so if it is a material, which does not release from the wrist of the user during the exercises, and is able to attach freely, then materials such as a rubber can be used.

Also the wrist stop has its both ends attached to the wrist part in a bow knot and the 8 knot, but it is a part device in order to keep a wrist for people, therefore if it is in a form in freely attachable, and not releasing the wrists, any from such as a ring may be used.

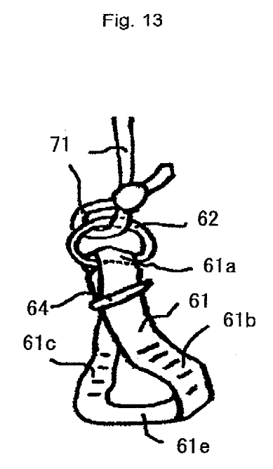

The applicant explains the third embodiment with the code of the FIG. 13.

The applicant changes a grip part to a shape-memory material in the third embodiment. A wrist part (61) consists of the material with flexibility, and it is the abbreviation rectangle. The wrist part (61) consists of an adherence part (61a), and both sides' parts (61b, 61c) and edge part (61e).

An attachment (62) has an equal function to the attachment (52) in the second embodiment. In this embodiment, a wrist part (61) is length about 22 cm, thick about 3 mm, width about 5 cm.

Both ends are sutured.

An adherence part (61a), which is composed of suturing the both ends of a wrist part (61), enables an attachment (62) to attach.

The attachment (62) is attached to the rope (71) for the exercise of the upper extremities. In this embodiment, a wrist part (61) is used a belt, which is about 5 mm width and about 12 cm length.

The belt is made of a material with flexibility and both ends of it are sewed on together. Namely the adherence part (61a) is formed as a slotted hole, which enables attachment (62) to pass through.

The wrist inserting position (3) in the second embodiment is a space where people's affected arm is inserted through and set, and made between the both sides part (61b, 61c) and a grip part (61e).

A grip part (61e) which is one end of the wrist device (61) is molded easy to grip with a shape-memory material such as a plastic water hose when it hangs in the rope (71) of the upper extremities exercise, as shown in FIG. 13.

In this embodiment, a peace of the plastic hose is sowed no together.

A wrist stop (54) consists of optional material, and it is correspondent with the wrist stop (4) of the second embodiment and containing the same shape and function.

The wrist stop is used a plastic ring fabricated hard to slip in this embodiment.

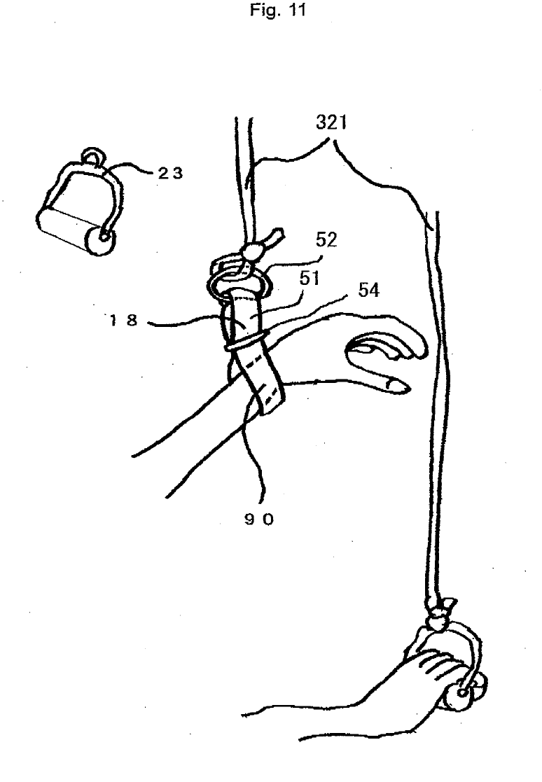

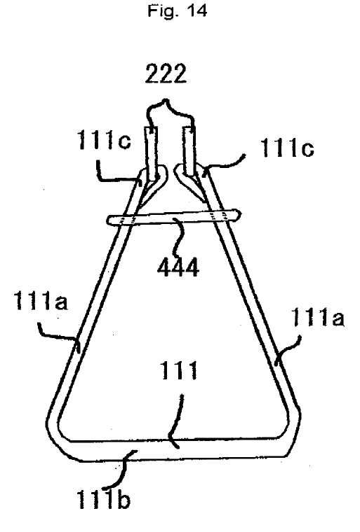

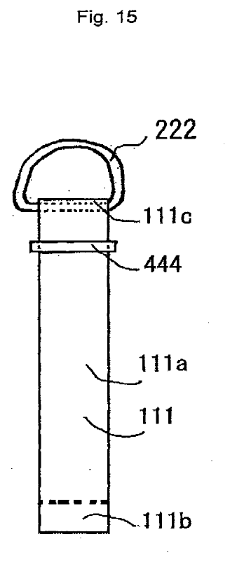

The applicant explains the forth embodiment with the codes of FIG. 14 and FIG. 15. This is an invention of a dual device of a grip and a wrist part, which is to process the circumference of a wrist in order to fix the wrist to prepare the exercise with the device to exercise the upper extremities of people and is composed of shape-memory fibers. It is possible to replace a grip (23) in the FIG. 11 by the effect of a dual grip end (111b). We can use a dual device when people do the motivative exercise and/or rehabilitation for the upper extremities.

In the utilization, insert the affected side wrist of people through at a wrist inserting position (3), which is constructed of the dual grip (111) that is attached onto a rope to exercise upper extremities by an attachment (222) and a wrist stop (444), which was movably attached to the dual grip (111), is moved to the place where the affected side wrist of people can't be escaped.

In this embodiment, a dual grip (111) consists of the material with flexibility and is the abbreviation flat triangle, which consists of cloth by shape-memory fibers.

And an internal side of the triangle of the dual grip, which center is opened with the three sides of triangle generally by shape-memory cloth, is a wrist setting part.

The dual grip (111) consists of a part to process the circumference of a wrist (111a), a dual grip end (111b), and fixing departments (111c).

The length from the dual grip end (111b) to the fixing department (111c) of each part to process the circumference of a wrist (111a) is 18 cm.

The length of the dual grip end (111b) is 10 cm, in between both sides of parts to process the circumference of a wrist (111a).

A fixing department (111c) is an end part to process the circumference of a wrist (111a), and attachment (222) is retained.

In this embodiment, it is sewed on but other means such as gluing is also possible.

The width of a dual grip (111) is about 5 cm, thickness is about 3 mm, and a dual grip end (111b) is formed by thickness 1.5 cm.

This length and width, thickness and forms are adequate for the Japanese people, and properly it is alterable.

An attachment (222) is composed to each side of both parts to process the circumference of a wrist (111a) by fixing departments (111c).

An attachment (222) is removable and attachable onto a rope to exercise upper extremities, for example a rope (321) in the FIG. 1.

In the second embodiment and the third embodiment, the part to process the circumference of a wrist had its ends sewn.

But for this embodiment, it is the composition to install each attachment part on each fixing department (111c).

However, it is also possible to sew up or glue the fixing department (111c) like the second embodiment and the third embodiment, on the edge in the part to process the circumference of a wrist and makes it to be integrated structure.

In other words, if it is attachable and removable freely to the rope to exercise upper extremities (321), a fixing department and an attachment could be in any form.

By the function of the shape-memory fiber, a dual grip is being molded in a form shown in FIG. 14, which is easy to hold like a grip, when it was hung in a rope of the upper extremities exercise (321).

A wrist stop (444) consists of optional material, and it is correspondent with the wrist stop (4) of the second embodiment and containing the same shape and function.

### USE POSSIBILITY IN INDUSTRY

Multiple kinds of products for care giving such as a lift from the bed that are used for gait difficulties or handicapped people who have difficulties even to get out of their beds in themselves and/or a bathing assistance device for them have been served in the prior art. But the practical uses of the lifting aids with wheels were poor in the environments of step difficulties.

A lifting aid of this invention can be used at ease because of the practical use is high and the labor of the care giver is reduced due to moving freely for the care work in the house with steps.

Heretofore, though it is the most desirable that the care giving is connected with the handicapped person's independence, its realization was difficult.

But now it is possible for handicapped people to be advance in independence from care reliance by providing the upper extremities exercise device for the motivative exercise in home available.

When a care giving devices are used at home it is mostly used in small areas, but this invention can be used in small areas effectively by having two purposes of using by one utensil.

The purposes are to use the functions of both a free movement of care works in the house with the obstacles such as a step and a rehabilitation device.

The hoisting accessory for the wound movement motion arm training device of this invention inserts wrist division or wrist of optional wound movement motion person diseased side arm for the wrist push in position in the wrist wrapping part, as the above be explained, and wrist stationary portion freely installed the aforesaid wrist wrapping part is lowering

The hand of the self is inserted for the wrist push in position, because it can campaign for the aforesaid wrist in the wound movement, and because it can be retained, the wound movement motion person whose the arm is handicapped lowers the wrist stationary portion, and it can be utilized alone.

This invention can be used to improve the necessity of keeping the expensive upper extremities training device in many and downsizes those to keep by using the invented shape-memory grips and to reduce the labor of the manager to make patients rehabilitate or persons begin motivative exercise with whose affected hand not easy to hold a grip due to fixing the affected hand to the grip using a device to keep a wrist.

And, it is possible to eliminate the necessity of installing the grip again after one person's or patient's exercise in order to keep the affected hand only by a device to keep a wrist, for another person and/or patient (or people) who can hold the grip by this invention.

Also, it is possible to eliminate the necessity of installing the belt-shaped band which has a clasp, to wear on the wrist at every time in use and to adjust to each people by this invention.

This invention can be used to reduce a labor in re-tying a grip and a rope through the rope in the hole of the grip, or to put over the glove-like device to on the hand with the paralysis to get fixed on to the grip.

And also it is possible to improve the usage of a grip, which is a combined structure by this invention.

It is possible to improve the necessity of keeping the expensive upper extremities training device in many and downsizes those to keep by using the invented shape-memory grips. And this invention make it possible to reduce the labor of the manager to make patients rehabilitate or persons begin motivative exercise with whose affected hand not easy to hold a grip due to fixing the affected hand to the grip using a device to keep a wrist. There was a necessity that a manager must wind the device to keep a wrist, which is published by the applicant to the wrist of people when people exercise their upper extremities which had invented by this applicant and to make one of two attachments path through the other one in order to install at the junction of the rope, therefore people cannot use the device alone.

It is possible to improve the above disablement and to stop the excessive tightening of a wrist by this invention and to use it individually.

It is possible to omit a grip by using a dual device and it is easier to use the dual device in the case of composing it by the shape memory material.

1: A part of an upper extremities training device for exercise and rehabilitation attaching a rope for upper extremities training, which is a dual device of using for upper extremities training that is a grip grasping by a hand of an unaffected side and a sling which enables to keen an affected side wrist of people by inserting an affected side wrist of people through a wrist part and moving a wrist stop;
a wrist part fabricating by a pliability shape-memory material with a space for wrist inserting position in case of attaching to a upper extremities training rope,
an attachment to attached said wrist part to a rope for the exercise of upper extremities; and
a wrist stop consists of optional materials, which is movably attached to said wrist part, and is moved to the place where an affected side wrist of people can't be escaped.

2: A part of a upper extremities training device for exercise and rehabilitation attaching a rope for upper extremities training, which is a dual device of using for upper extremities training that is a grip grasping by a hand of an unaffected side and a sling which enables to keep an affected side wrist of people by inserting the affected side wrist of people through a wrist part and moving a wrist stop including:
a wrist part fabricating by a pliability shape-memory material with a space for wrist inserting position in case of attaching to a upper extremities training rope;
said wrist part, which is fixing on the edge is a integrated structure, wherein an attachment to attached said wrist part to a rope for the exercise of the upper extremities integrated into said wrist part; and
a wrist stop consists of optional materials, which is movably attached to said wrist part, and is moved to the place where the affected side wrist of people can't be escaped.

3. (canceled)
